(19) United States
(12) Patent Application Publication
(10) Pub. No.: US 2026/0367549 A1
(43) Pub. Date: Nov. 19, 2026

(54) FIXING DEVICE

(71) Applicant: CANON KABUSHIKI KAISHA, Tokyo (JP)

(72) Inventors: MASAKI FURUTANI, Chiba (JP); TAKUYA HASEGAWA, Tokyo (JP); KENICHI TANAKA, Ibaraki (JP); RIKIYA TAKEMASA, Chiba (JP); TAKESHI KOZUMA, Ibaraki (JP); TATSUO YASUI, Tokyo (JP)

(21) Appl. No.: 19/676,977

(22) Filed: May 14, 2026

(30) Foreign Application Priority Data
May 19, 2025 (JP) 2025-083646

(51) Int. Cl. G03G 15/20

(52) U.S. Cl. CPC G03G 15/2025; G03G 15/2064; G03G 2215/2038

(57) ABSTRACT

A fixing device includes an endless belt member having an inner peripheral surface onto which a lubricant is applied and a detection unit configured to detect a position of the belt member in a width direction intersecting a rotation direction of the belt member. The detection unit includes a pivot shaft extending in a direction intersecting the width direction, a base end portion configured to pivot about the pivot shaft, a contact portion continuous with the base end portion, contacting an end portion, in the width direction, of the belt member, and configured to pivot about the pivot shaft together with the base end portion as the belt member moves in the width direction, and a protrusion portion continuous with the contact portion, and protruding toward the center of the belt member relative to the contact portion in the width direction.

### BACKGROUND

### Field of the Technology

The present disclosure relates to a fixing device that fixes a toner image to a recording material by heating the toner image borne on the recording material.

### Description of the Related Art

An image forming apparatus such as a copying machine, a printer, a facsimile, or a multifunction peripheral having a plurality of functions thereof includes a fixing device that fixes a toner image borne on a recording material to the recording material. JP 2003-195671 A discloses a configuration in which a toner image on a recording material is conveyed while being heated in a nip portion formed by an endless belt member and a rotary member.

In addition, in a fixing device using a belt member, a lubricant is applied in advance onto an inner peripheral surface of the belt member in order to improve the slidability on the inner peripheral surface of the belt member. Further, JP 2022-006228 A discloses a configuration in which a detection unit contacting an end surface of a belt member to detect a position of a belt member in a width direction is provided, and the belt member is controlled to reciprocate in a predetermined region in the width direction according to a detection result. In order to suppress leakage of a lubricant on the inner peripheral surface of the belt member, JP 2022-006228 A discloses a method in which a protrusion portion protruding toward an inner peripheral surface of the belt member is provided in a belt detection arm to cause the lubricant to drop onto the inner peripheral surface of the belt member.

### SUMMARY

The present disclosure provides a configuration capable of suppressing leakage of a lubricant on an inner peripheral surface of a belt member.

According to one aspect of the present disclosure, a fixing device configured to fix a toner image to a recording material by heating the toner image borne on the recording material, the fixing device includes an endless belt member having an inner peripheral surface onto which a lubricant is applied, a rotary member configured to rotate in contact with an outer peripheral surface of the belt member, and to form a nip portion with the belt member, the nip portion nipping and conveying the recording material, a detection unit configured to detect a position of the belt member in a width direction intersecting a rotation direction of the belt member, and, a steering roller configured to stretch the belt member, the steering roller being tilted to move the belt member in the width direction according to a detection result of the detection unit. The detection unit includes a pivot shaft extending in a direction intersecting the width direction, a base end portion configured to pivot about the pivot shaft, a contact portion continuous with the base end portion, contacting an end portion, in the width direction, of the belt member, and configured to pivot about the pivot shaft together with the base end portion as the belt member moves in the width direction, and, a protrusion portion continuous with the contact portion, and protruding toward the center of the belt member relative to the contact portion in the width direction. The contact portion is continuous with the base end portion in a state in which a line connecting one end portion thereof contacting the belt member in a pivot direction around the pivot shaft and the other end portion thereof opposite to the belt member is inclined with respect to a plane orthogonal to the pivot shaft such that the one end portion is located below the other end portion in a direction of gravity, regardless of the position of the belt member in the width direction. The protrusion portion has a distal end portion located below the contact portion in the direction of gravity and in a region overlapping the inner peripheral surface of the belt member in the width direction to guide the lubricant from the contact portion to the inner peripheral surface of the belt member.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating a configuration of an image forming apparatus according to an embodiment.

FIG. 2 is a schematic cross-sectional view illustrating a configuration of a fixing device according to the embodiment.

FIG. 3A is a schematic cross-sectional view of a configuration of a steering roller according to the embodiment.

FIG. 3B is a cross-sectional view taken along line A-A in FIG. 3A.

FIG. 4A is a perspective view of the vicinity of the steering roller according to the embodiment.

FIG. 4B is a schematic view illustrating how the steering roller is tilted.

FIG. 5 is a perspective view illustrating a configuration for detecting a position of an end surface of a fixing belt according to the embodiment.

FIG. 6 is a view of the vicinity of a belt position detection arm according to the embodiment as viewed from a lower side in a direction of gravity.

FIG. 7 is a view of the vicinity of the belt position detection arm according to the embodiment as viewed from a width direction.

FIG. 8 is a cross-sectional view taken along line E-E in FIG. 6.

### DESCRIPTION OF THE EMBODIMENTS

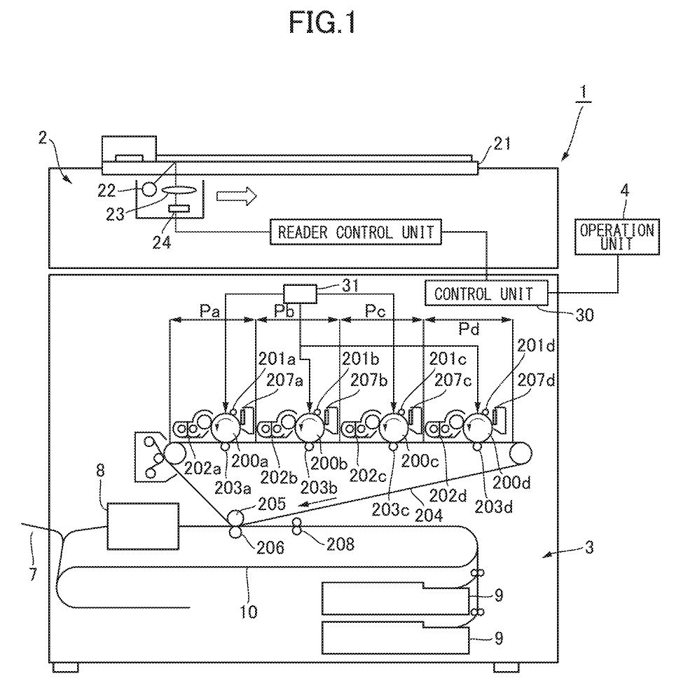

An embodiment will be described with reference to FIGS. 1 - 8. First, a schematic configuration of an image forming apparatus according to the present embodiment will be described with reference to FIG. 1.

### Image Forming Apparatus

The image forming apparatus 1 is an electrophotographic full-color printer including four image forming units Pa, Pb, Pc, and Pd provided to correspond to four colors of yellow, magenta, cyan, and black. In the present embodiment, the image forming units Pa, Pb, Pc, and Pd are arranged in a tandem type along a rotation direction of an intermediate transfer belt 204 to be described below. The image forming apparatus 1 forms a toner image (image) on a recording material according to an image signal from an image reading unit (document reading device) 2 connected to an image forming apparatus body 3 or a host device such as a personal computer communicably connected to the image forming apparatus body 3. Examples of the recording material include sheet materials such as paper, a plastic film, and cloth.

The image forming apparatus 1 includes an image reading unit 2 and an image forming apparatus body 3. The image reading unit 2 reads a document placed on a platen glass 21. Light emitted from a light source 22 is reflected by the document, and an image is formed on a CCD sensor 24 via an optical system member 23 such as a lens. Such an optical system unit converts the document into an electric signal data string for each line by scanning the document in an arrow direction. The image signal obtained by the CCD sensor 24 is sent to the image forming apparatus body 3, and a control unit 30 performs image processing in accordance with each image forming unit to be described below. The control unit 30 also receives an external input from an external host device such as a print server as an image signal.

The image forming apparatus body 3 includes a plurality of image forming units Pa, Pb, Pc, and Pd, and each of the image forming unit forms an image based on the above-described image signal. That is, the image signal is converted into a laser beam subjected to pulse width modulation (PWM) by the control unit 30. A polygon scanner 31 serving as an exposing unit scans the laser beam corresponding to the image signal. Then, photosensitive drums 200a to 200d which serve as image bearing members of the image forming units Pa to Pd are irradiated with a laser beam.

Note that Pa, Pb, Pc, and Pd, which denote an image forming unit for yellow (Y), an image forming unit for magenta (M), an image forming unit for cyan (C), and an image forming unit for black (Bk), respectively, form images of corresponding colors. Since the image forming units Pa to Pd are substantially the same, the image forming unit Pa for Y will be described in detail below, and the description of the other image forming units will be omitted. In the image forming unit Pa, a toner image is formed on a surface of the photosensitive drum 200a based on the image signal as will be described below.

A charging roller 201a serving as a primary charger charges the surface of the photosensitive drum 200a to a predetermined potential to prepare for forming an electrostatic latent image. An electrostatic latent image is formed on the surface of the photosensitive drum 200a charged to the predetermined potential by a laser beam from the polygon scanner 31. A developing unit 202a develops the electrostatic latent image on the photosensitive drum 200a to form a toner image. A primary transfer roller 203a performs discharging from a back surface of the intermediate transfer belt 204, applies a primary transfer bias having a polarity opposite to that of the toner, and transfers the toner image on the photosensitive drum 200a onto the intermediate transfer belt 204. After the transfer, the surface of the photosensitive drum 200a is cleaned by a cleaner 207a.

In addition, the toner image on the intermediate transfer belt 204 is conveyed to the next image forming unit, and toner images for the respective colors formed by the respective image forming units are sequentially transferred in the order of Y, M, C, and Bk, and images of four colors are formed on the surface thereof. Then, the toner image having passed through the image forming unit Pd for Bk located on the most downstream side in the rotation direction of the intermediate transfer belt 204 is conveyed to a secondary transfer portion including a pair of secondary transfer rollers 205 and 206. Then, in the secondary transfer portion, a secondary transfer electric field having a polarity opposite to that of the toner images on the intermediate transfer belt 204 is applied, thereby secondarily transferring the toner images to the recording material.

The recording material is accommodated in a cassette 9, and the recording material fed from the cassette 9 is conveyed to, for example, a registration portion 208 including a pair of registration rollers, and stands by at the registration portion 208. Thereafter, the registration portion 208 conveys the recording material to the secondary transfer portion at a timing controlled to align the toner images on the intermediate transfer belt 204 and the paper.

The recording material to which the toner images have been transferred by the secondary transfer portion is conveyed to a fixing device 8, and the toner images borne on the recording material are fixed to the recording material by being heat-pressurized in the fixing device 8. The recording material having passed through the fixing device 8 is discharged to a sheet discharge tray 7. Note that, in a case where images are formed on both surfaces of the recording material, when toner images are transferred and fixed to a first surface (front surface) of the recording material, the front and back surfaces of the recording material are reversed via a reverse conveyance portion 10, toner images are transferred and fixed to a second surface (back surface) of the recording material, and the recording material is placed on the sheet discharge tray 7.

Note that the control unit 30 controls the entire image forming apparatus 1 as described above. Furthermore, the control unit 30 can perform various settings and the like based on an input from an operation unit 4 included in the image forming apparatus 1. The control unit 30 includes a central processing unit (CPU), a read only memory (ROM), and a random access memory (RAM). The CPU controls each unit while reading a program corresponding to the control procedure stored in the ROM. In addition, work data and input data are stored in the RAM, and the CPU performs control with reference to the data stored in the RAM based on the above-described program or the like.

### Fixing Device

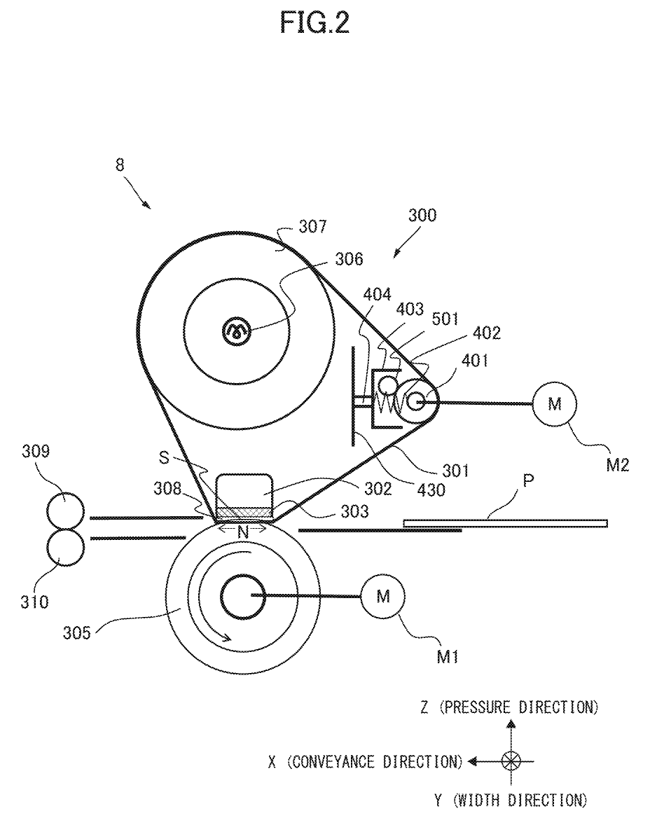

Next, a configuration of the fixing device 8 according to the present embodiment will be described with reference to FIG. 2. FIG. 2 is a cross-sectional view schematically illustrating a schematic configuration of the fixing device 8. In the present embodiment, a belt heating type fixing device using an endless belt member is adopted. In FIG. 2, an X direction represents a conveyance direction of the recording material P, a Y direction represents a width direction intersecting (in the present embodiment, orthogonal to) the conveyance direction of the recording material P, and a Z direction represents a pressure direction of a pressure roller 305 to be described below. These directions are orthogonal to each other. Further, one side in the width direction (Y direction) is a front side of the image forming apparatus 1, for example, a side on which the operation unit 4 is disposed and operated by a user. On the other hand, the other side in the width direction is a back side of the image forming apparatus 1.

The fixing device 8 includes a heating unit 300 having a fixing belt 301 serving as an endless rotatable belt member, and a pressure roller 305 serving as a rotary member that contacts the fixing belt 301 and forms a nip portion N together with the fixing belt 301.

The heating unit 300 includes the fixing belt 301 described above, a fixing pad 303 serving as a pad member, a steering roller 401, a heating roller 307 serving as a stretching roller, and a lubricant supply roller 501. The pressure roller 305 is also a driving rotary member that rotates in contact with an outer peripheral surface of the fixing belt 301 to apply a driving force to the fixing belt 301.

The fixing belt 301 serving as a fixing member and a rotary member has thermal conductivity, heat resistance, and the like, and has a thin cylindrical shape. In the present embodiment, the fixing belt 301 has a three-layer structure in which a base layer, an elastic layer on the outer periphery of the base layer, and a release layer on the outer periphery of the elastic layer are formed. Further, a polyimide resin (PI) is used as a material for the base layer having a thickness of 80 μm, a silicone rubber is used for the elastic layer having a thickness of 300 μm, and PFA (tetrafluoroethylene/perfluoroalkoxyethylene copolymer resin) is used as a fluororesin for the release layer having a thickness of 30 μm. The fixing belt 301 is stretched by the fixing pad 303, the heating roller 307, and the steering roller 401.

A lubricant is applied onto an inner peripheral surface of the fixing belt 301 in advance. The lubricant is, for example, silicone oil. Note that, as will be described below, if a lubricant is interposed between the fixing pad 303 and the fixing belt 301, it is not necessary to apply the lubricant in advance to the inner peripheral surface of the fixing belt 301. This is because when the fixing belt 301 rotates, the lubricant between the fixing pad 303 and the fixing belt 301 is applied onto the entire inner peripheral surface of the fixing belt 301.

The fixing pad 303 is disposed inside the fixing belt 301 in a non-rotating manner so as to face the pressure roller 305 with the fixing belt 301 interposed therebetween. The fixing pad 303 forms the nip portion N for nipping and conveying the recording material between the fixing belt 301 and the pressure roller 305. In the present embodiment, the fixing pad 303 is a substantially plate-like member that is long along the width direction of the fixing belt 301 (a longitudinal direction intersecting with the rotation direction of the fixing belt 301 and a rotation axis direction of the heating roller 307). The nip portion N is formed by pressing the fixing pad 303 against the pressure roller 305 with the fixing belt 301 interposed therebetween. As a material for the fixing pad 303, a liquid crystal polymer (LCP) resin is used.

A lubricating sheet 308 whose surface is coated with polytetrafluoroethylene (PTFE) and silicone oil S (hereinafter, oil S) serving as a lubricant are interposed between the fixing pad 303 and the fixing belt 301, so that the fixing belt 301 smoothly slides with respect to the fixing pad 303. The silicone oil S is preferably the same oil as the silicone oil applied in advance onto the inner surface of the fixing belt 301. The lubricating sheet 308 is formed by coating a surface of a polyimide base material having a thickness of 70 μm with PTFE. Note that, since the lubricating sheet 308 is provided to improve the slidability between the fixing pad 303 and the fixing belt 301, the lubricating sheet 308 can be substituted with a coating or the like applied onto a surface layer of the fixing pad 303 to improve slidability.

The fixing pad 303 is supported by a stay 302 serving as a support member disposed inside the fixing belt 301. That is, the stay 302 is disposed on a side of the fixing pad 303 opposite to the pressure roller 305 to support the fixing pad 303. The stay 302, which is a reinforcing member having rigidness and a long length along the longitudinal direction of the fixing belt 301, contacts the fixing pad 303 to support the fixing pad 303 from the back. That is, when the fixing pad 303 is pressed against the pressure roller 305, the stay 302 imparts strength to the fixing pad 303 to secure the pressurizing force in the nip portion N.

The heating roller 307 is disposed inside the fixing belt 301 to stretch the fixing belt 301 together with the fixing pad 303 and the steering roller 401. The heating roller 307 is formed of metal such as aluminum or stainless steel in a cylindrical shape, and a halogen heater 306 serving as a heating portion for heating the fixing belt 301 is disposed inside the heating roller 307. Then, the heating roller 307 is heated to a predetermined temperature by the halogen heater 306.

In the present embodiment, the heating roller 307 is formed of, for example, a stainless steel pipe having a thickness of 1 mm. One or more halogen heaters 306 may be installed. Note that the heating unit is not limited to the halogen heater, and may be another heater capable of heating the heating roller 307, such as a carbon heater. The fixing belt 301 is heated by the heating roller 307 heated by the halogen heater 306, and is controlled to a predetermined target temperature corresponding to the type of recording material based on a temperature detected by a thermistor, which is not illustrated.

The steering roller 401 is disposed inside the fixing belt 301, stretches the fixing belt 301 together with the fixing pad 303 and the heating roller 307, and rotates following the rotation of the fixing belt 301. In the present embodiment, the steering roller 401 is also a tension roller biased by a biasing spring 402 serving as a biasing member supported by a frame 430 of the heating unit 300 to apply a predetermined tension to the fixing belt 301.

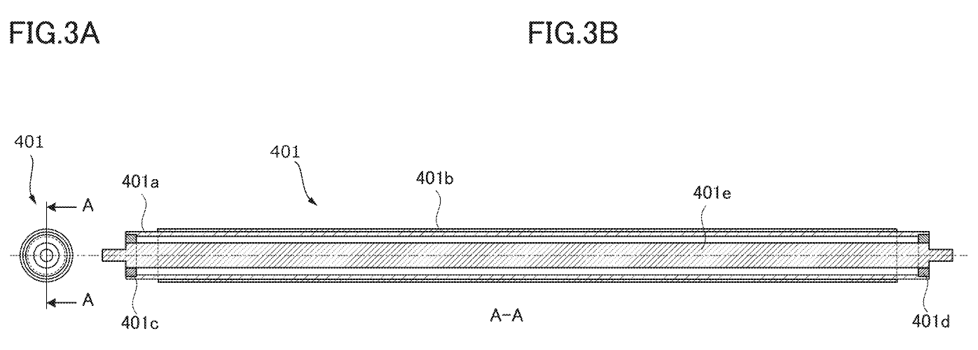

As illustrated in FIGS. 3A and 3B, the steering roller 401 includes a cylindrical member 401a and an elastic layer 401b disposed around the cylindrical member 401a. FIG. 3A is a cross-sectional view of the steering roller 401 taken along a direction orthogonal to the rotation axis direction, and FIG. 3B is a cross-sectional view of the steering roller 401 taken along the rotation axis direction. For example, the cylindrical member 401a is a stainless pipe having an outer diameter of 20 mm and a thickness of 1 mm, and the elastic layer 401b is formed of a silicone rubber layer having a thickness of 100 μm.

As illustrated in FIG. 3B, both end portions of the steering roller 401 in the longitudinal direction (rotation axis direction) are rotatably supported by bearings 401c and 401d, respectively. That is, the bearings 401c and 401d are disposed at both end portions of the rotation support shaft 401e in the longitudinal direction, and the cylindrical member 401a is rotatably supported by the rotation support shaft 401e via the bearings 401c and 401d at both ends thereof. Therefore, the steering roller 401 rotates following the fixing belt 301 in a state where it is supported by the rotation support shaft 401e via the bearings 401c and 401d.

The lubricant supply roller 501 serving as a lubricant supply unit is in contact with the steering roller 401 inside the fixing belt 301, and is disposed so as to be tiltable together with the steering roller 401 with respect to a direction parallel to the rotation axis direction of the heating roller 307. The lubricant supply roller 501 supplies a lubricant to the steering roller 401. The lubricant supplied to the steering roller 401 is supplied to the inner peripheral surface of the fixing belt 301. That is, in the present embodiment, the lubricant supply roller 501 supplies the lubricant to the fixing belt 301 via the steering roller 401. The lubricant supplied from the lubricant supply roller 501 is, for example, silicone oil, and is preferably the same oil as the silicone oil applied in advance onto the inner surface of the fixing belt 301.

The pressure roller 305 rotates in contact with the outer peripheral surface of the fixing belt 301 to apply a driving force to the fixing belt 301. In the present embodiment, the pressure roller 305 is a roller in which an elastic layer is formed on an outer periphery of a shaft and a releasable layer is formed on an outer periphery of the elastic layer. Further, stainless steel having a diameter of 72 mm is used for the shaft, conductive silicone rubber having a thickness of 8 mm is used for the elastic layer, and PFA (tetrafluoroethylene/perfluoroalkoxyethylene copolymer resin) is used as a fluororesin having a thickness of 100 μm for the releasable layer. The pressure roller 305 is rotatably supported by a fixing frame (not illustrated) of the fixing device 8, while one end to which a gear is fixed, and is connected to a motor M1 serving as a pressure roller driving source via the gear to be rotationally driven.

In the fixing device 8 configured as described above, a toner image is heated while the recording material P bearing the toner image is conveyed in a nipped state in the nip portion N formed between the fixing belt 301 and the pressure roller 305. Then, the toner image is fixed to the recording material P. Therefore, the fixing device 8 needs to have both a function of applying heat and pressure and a function of conveying the recording material P. The pressure roller 305 is pressed against the fixing pad 303 via the fixing belt 301 by a driving source that is not illustrated. In the present embodiment, the pressurizing force (NF) in the nip portion N for forming an image is set to 1600 N, the length of the nip portion N in the X direction (conveyance direction) is set to 24.5 mm, and the length of the nip portion N in the Y direction (width direction) is set to 326 mm. Further, a sheet discharge roller pair 309 and 310 for discharging the recording material P having passed through the nip portion N to the outside of the fixing device 8 is disposed downstream of the nip portion N in the conveyance direction of the recording material P.

### Steering Unit

The steering roller 401 in the fixing device 8 according to the present embodiment is disposed so that its rotation axis is tiltable with respect to a predetermined direction parallel to the rotation axis direction (width direction and longitudinal direction) of the heating roller 307. By tilting the steering roller 401, the position (shifted position) of the fixing belt 301 with respect to the rotation axis direction of the heating roller 307 is controlled. That is, the steering roller 401 has a pivot center at the center or one end portion of the steering roller 401 in the rotation axis direction (longitudinal direction), and swings about the pivot center to tilt with respect to the longitudinal direction of the heating roller 307. As a result, a tension difference is generated between one side and the other side of the fixing belt 301 in the longitudinal direction, thereby moving the fixing belt 301 in the longitudinal direction.

The fixing belt 301 is shifted toward one end portion during rotation depending on the accuracy in the outer diameter of the roller stretching the fixing belt 301, the accuracy in the alignment between the rollers, and the like. Therefore, such a shift is controlled by the steering roller 401 that also serves as a steering roller. The steering roller 401 may be swung by a drive source such as a motor, or may be configured to swing by self-alignment.

The steering roller 401 according to the present embodiment will be described in more detail. As illustrated in FIG. 2, the steering roller 401 stretches the fixing belt 301, and is supported by the steering unit 403. The steering unit 403 pivots with respect to the frame 430 of the heating unit 300 about a pivot shaft 404 as a fulcrum, so that the steering roller 401 is supported in such a manner as to change an angle of contact with the fixing belt 301.

Both end portions of the steering roller 401 are biased to one side of the fixing belt 301 at 50 N by the biasing spring 402 supported by the steering unit 403, and the steering roller 401 also serves as a tension roller that applies a predetermined tension to the fixing belt 301. That is, the steering roller 401 according to the present embodiment has both a function as a steering roller and a function as a tension roller.

### Steering Operation

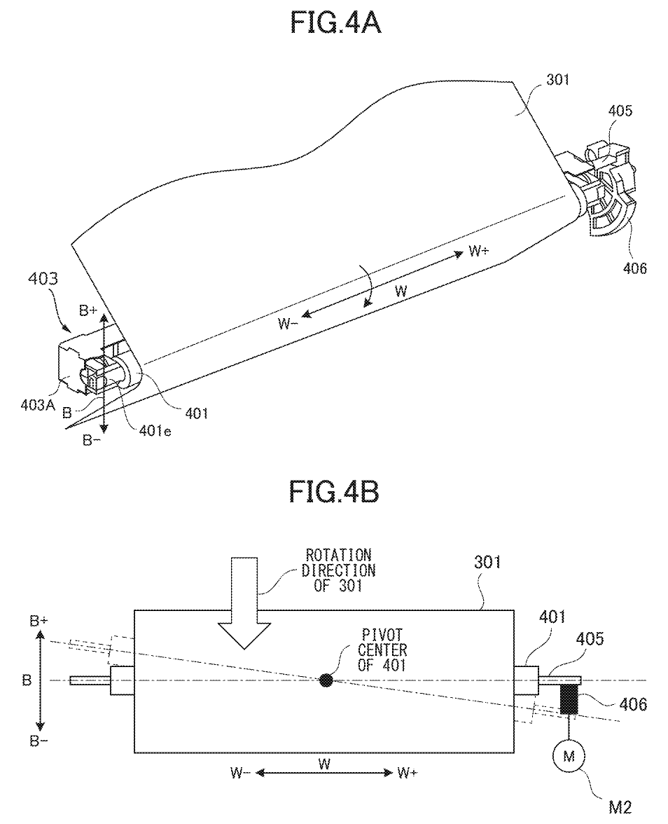

The steering operation of the steering roller 401 will be described with reference to FIGS. 4A and 4B. FIG. 4A is a perspective view of the vicinity of the steering roller 401 stretching the fixing belt 301, and FIG. 4B is a schematic view illustrating how the steering roller 401 is tilted together with the fixing belt 301.

As described above, the steering roller 401 is supported to be pivotable with respect to the frame 430 of the heating unit 300 via the steering unit 403. The steering unit 403 includes a steering body portion 403A that supports the steering roller 401 via the rotation support shaft 401e, a steering shaft 405 provided at an end portion of the steering body portion 403A, and a steering arm 406. The steering arm 406 is driven by a motor M2 as a driving unit that tilts the steering roller 401, and swings the steering shaft 405 in a direction indicated by an arrow B in FIGS. 4A and 4B. As a result, the steering body portion 403A pivots about the pivot shaft 404 (FIG. 2) via the steering shaft 405, so that the steering roller 401 can change the angle with respect to the fixing belt 301.

By changing the angle of the steering roller 401 as described above, the fixing belt 301 stretched thereby moves along the width direction (longitudinal direction) W. In a case where the steering roller 401 is tilted in a direction indicated by an arrow B+ in FIGS. 4A and 4B, the fixing belt 301 is moved in a direction indicated by an arrow W- in FIGS. 4A and 4B toward a front side of the fixing device 8 (a control of a forward shift of the belt). On the other hand, in a case where the steering roller 401 is tilted in a direction indicated by an arrow B- in FIGS. 4A and 4B, the fixing belt 301 is moved in a direction indicated by an arrow W+ in FIGS. 4A and 4B toward a back side of the fixing device 8 (a control of a backward shift of the belt). By repeating this operation, the fixing belt 301 reciprocates in a predetermined region in the width direction W. The position of the fixing belt 301 in the width direction W, that is, the shifted position, is detected by a shifted position detection unit 410A, which will be described below, and the steering roller 401 is tilted so as to move the fixing belt 301 in the width direction W according to the detection result of the shifted position detection unit 410A.

### Detection of Shifted Position of Fixing Belt

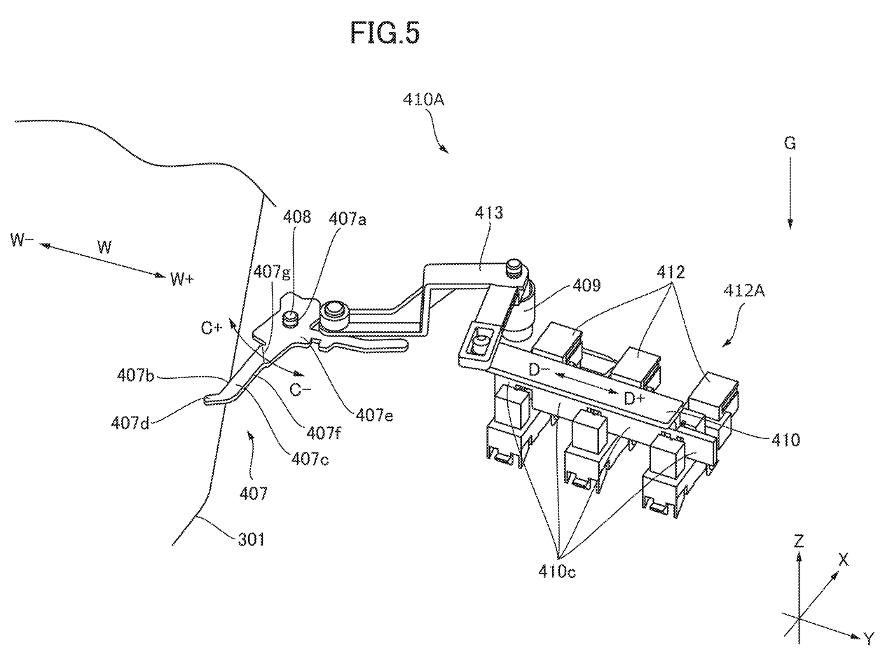

Next, the shifted position detection unit 410A serving as a detection unit will be described with reference to FIG. 5. The shifted position detection unit 410A includes a belt position detection arm 407, a belt position detection flag 410, a biasing unit 409, and a sensor unit 412A. The belt position detection arm 407 is rotatably held in a state where a pivot center hole 407a is fitted to a pivot shaft 408, and the belt position detection flag 410 is provided as a flag member that linearly moves in conjunction with the belt position detection arm 407 via a link arm 413. The belt position detection flag 410 is biased to linearly move in a direction indicated by an arrow D+ in FIG. 5 by the biasing unit 409 provided on a pivot shaft of the link arm 413. As a result, the belt position detection arm 407 is biased to rotate in a direction indicated by an arrow C+ in FIG. 5. A detection portion 407c serving as a contact portion provided in the belt position detection arm 407 is in contact with an end surface of the fixing belt 301 at a light pressure that does not hinder the movement of the fixing belt 301 in the width direction W with the biasing force. In the present embodiment, this pressure is set to about 1 gf.

The sensor unit 412A includes a plurality of optical sensors 412. The belt position detection flag 410 includes light shielding portions 410c, and a plurality of optical sensors 412 are provided near the light shielding portions 410c. When the position of the belt position detection flag 410 changes and the light shielding portions 410c move, the on/off states of signals returned by the optical sensors 412 also change, so that the position of the fixing belt 301 can be detected by a combination of the signals. By combining the control of the motor M2 of the steering arm 406 described above and the shifted position detection unit 410A using the belt position detection flag 410, a shift of the fixing belt 301 is controlled.

### Leakage of Lubricant from Inner Peripheral Surface of Fixing Belt

As described above, the lubricant is applied onto the inner peripheral surface of the fixing belt 301. In the present embodiment, the lubricant is further supplied from the lubricant supply roller 501 to the inner peripheral surface of the fixing belt 301 via the steering roller 401. For this reason, there is a possibility that the lubricant on the inner surface of the fixing belt 301 reaches an end portion of the fixing belt 301 in the width direction and adheres to the belt position detection arm 407 that is in contact with the end surface of the fixing belt 301. When the lubricant adheres to the belt position detection arm 407, there is a possibility that the lubricant travels along the belt position detection arm 407 and leaks from the inner surface of the fixing belt 301.

For this reason, in JP 2022-006228 A, which is mentioned above, the belt position detection arm has a protrusion portion protruding toward the inner peripheral surface of the fixing belt, such that the lubricant adhering to the belt position detection arm is guided to the inner peripheral surface of the fixing belt via the protrusion portion. However, if the fixing device is downsized, the space inside the fixing belt decreases, making it difficult to secure the protruding amount of the protrusion portion of the belt position detection arm and the downward inclination angle in the direction of gravity. In this case, the lubricant is not guided to the distal end of the protrusion portion of the belt position detection arm, and there is a possibility that another adjacent member is contaminated with the lubricant. In addition, there is a possibility that the lubricant drips from the member contaminated with the lubricant onto the recording material conveyed through the nip portion of the fixing device, thereby contaminating the image. Furthermore, if there is a path along which the lubricant leaks from the inner peripheral surface of the fixing belt, the lubricant existing on the inner peripheral surface of the fixing belt becomes insufficient over time, and there is a possibility that the slidability on the inner peripheral surface of the fixing belt deteriorates.

### Countermeasure for Preventing Lubricant Leakage According to Present Embodiment

Therefore, in the present embodiment, the configuration to be described below is adopted so that, even when it is difficult to secure the protruding amount of the protrusion portion 407d of the belt position detection arm 407 and the downward inclination angle in the direction of gravity, leakage of the lubricant on the inner peripheral surface of the fixing belt 301 is suppressed. Hereinafter, the countermeasure for preventing lubricant leakage according to the present embodiment will be described with reference to FIGS. 5 - 8.

As illustrated in FIG. 5, the belt position detection arm 407 according to the present embodiment includes a base end portion 407e, a detection portion 407c serving as a contact portion, and a protrusion portion 407d. The base end portion 407e, the detection portion 407c, and the protrusion portion 407d are formed as a single member, but may be formed by connecting one or more members as separate members. The base end portion 407e pivots about the pivot shaft 408. The pivot shaft 408 extends in a direction (the direction of gravity in the present embodiment) intersecting the width direction. The detection portion 407c is continuous with the base end portion 407e, and is in contact with an end portion of the fixing belt 301 in the width direction. As the fixing belt 301 moves in the width direction, the detection portion 407c pivots together with the base end portion 407e about the pivot shaft 408. The protrusion portion 407d is continuous with the detection portion 407c, and protrudes toward the center of the fixing belt 301 relative to the detection portion 407c in the width direction.

In the present embodiment, each of the detection portion 407c and the base end portion 407e is a plate-shaped member, and the detection portion 407c is continuous so as to be bent with respect to the base end portion 407e. In addition, the protrusion portion 407d protrudes in a direction intersecting the extending direction of the detection portion 407c from an end portion of the detection portion 407c on a side opposite to a continuous portion 407g, by which the detection portion 407c and the base end portion 407e are continuous with each other, with respect to the extending direction of the detection portion 407c from the base end portion 407e.

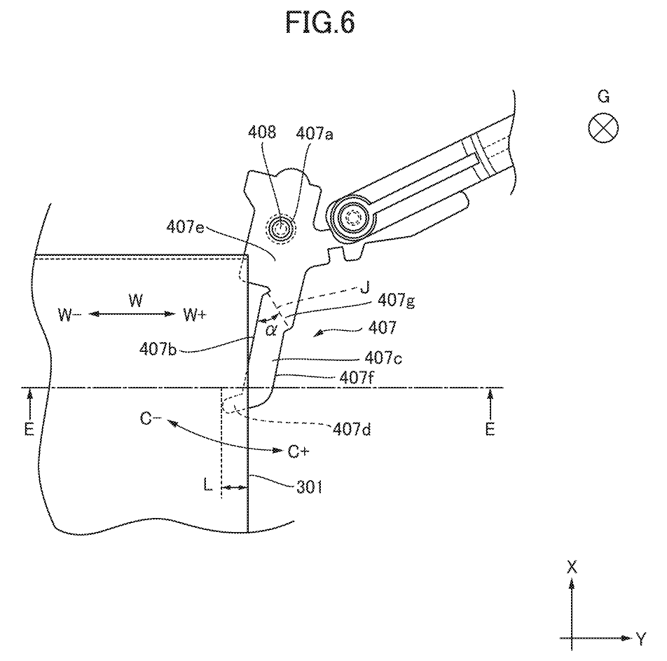

FIG. 6 is a view of the vicinity of the belt position detection arm 407 as viewed from the lower side (Z- direction) in the direction of gravity in FIG. 5. The detection portion 407c has a detection surface 407b serving as a contact surface that is in contact with the end surface in the width direction of the fixing belt 301 at one end portion that is in contact with the fixing belt 301 in a pivot direction (a direction indicated by an arrow C) about the pivot shaft 408. The protrusion portion 407d is formed continuously with the detection surface 407b, and is provided below the detection surface 407b in the direction of gravity G. The protrusion portion 407d protrudes such that its distal end is directed toward the center in the width direction W relative to the end surface of the fixing belt 301. That is, the protrusion portion 407d is located in a region overlapping the inner peripheral surface of the fixing belt 301 in the width direction W, with its distal end being below the detection portion 407c in the direction of gravity. The protrusion portion 407d guides the lubricant from the detection portion 407c to the inner peripheral surface of the fixing belt 301.

A distal end of the protrusion portion 407d is required to be located inside the fixing belt 301 in the width direction W relative to the end surface of the fixing belt 301 regardless of the posture angle of the belt position detection arm 407. A distance L in the width direction W from the distal end of the protrusion portion 407d to the end surface of the fixing belt 301 decreases when the fixing belt 301 moves in the width direction W+, that is, when the belt position detection arm 407 moves in the C+ direction. In the present embodiment, the protrusion portion 407d is formed such that L ≥ 2 mm even if the distance L decreases due to the movement of the fixing belt 301. That is, the protrusion portion 407d protrudes from the detection portion 407c such that the distance L between the distal end of the protrusion portion 407d and the end portion of the fixing belt 301 in the width direction in contact with the detection portion 407c is 2 mm or more regardless of the position of the fixing belt 301 in the width direction W.

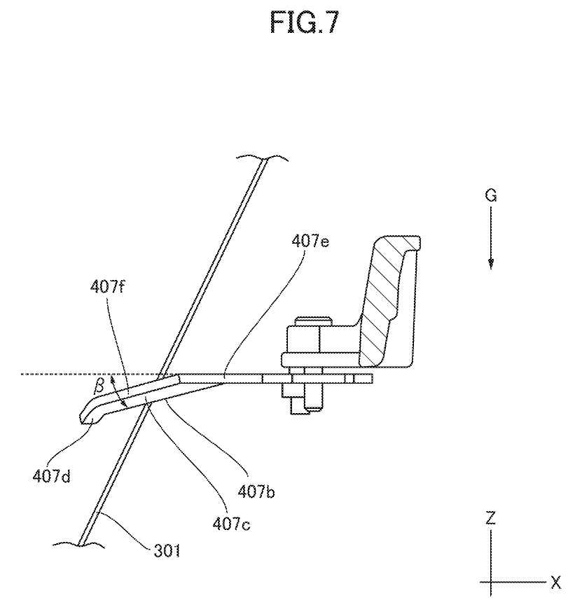

FIG. 7 is a view of the vicinity of the belt position detection arm 407 as viewed from the width direction (Y+ direction) in FIG. 5. As the fixing belt 301 runs for a while, the excess lubricant on the inner peripheral surface of the fixing belt 301 reaches the end surface of the fixing belt 301, and adheres to the detection surface 407b of the belt position detection arm 407 that is in contact with the end surface of the fixing belt 301. The adhering lubricant travels along the surface of the detection portion 407c in the direction of gravity G while maintaining contact with the detection surface 407b due to its own viscosity. In the present embodiment, the detection portion 407c is inclined with respect to the base end portion 407e such that the end portion of the detection portion 407c on the side where the protrusion portion 407d is provided is located below the continuous portion 407g continuous with the base end portion 407e in the direction of gravity. That is, the detection portion 407c is inclined by an angle β from the horizontal direction toward the direction of gravity. Since the protrusion portion 407d is located below the detection surface 407b in the direction of gravity G, the lubricant adhering to the belt position detection arm 407 is guided toward the protrusion portion 407d. Since the distal end portion of the protrusion portion 407d is located in the region overlapping the inner peripheral surface of the fixing belt 301 in the width direction W, the lubricant guided to the protrusion portion 407d is returned to the inner peripheral surface of the fixing belt 301.

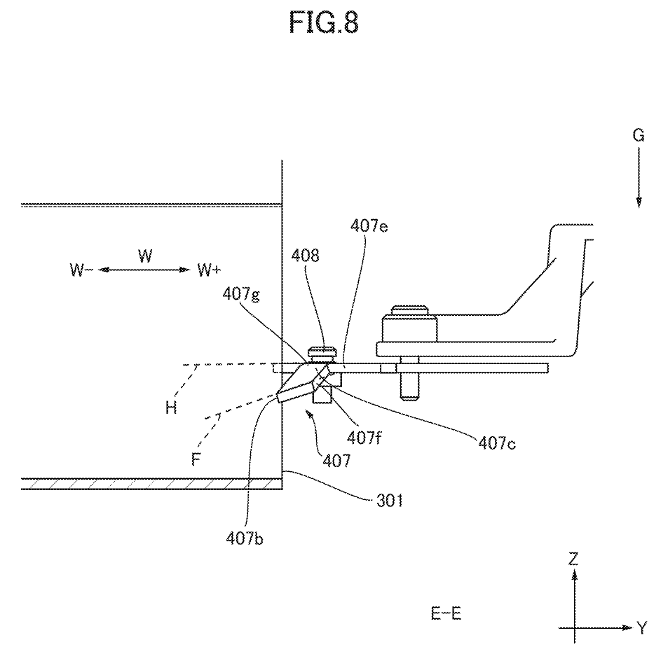

In particular, in the present embodiment, in addition to the detection portion 407c being inclined by the angle β from the horizontal direction toward the direction of gravity, the detection portion 407c is connected to the base end portion 407e so as to be twisted as illustrated in FIG. 8. Here, in the pivot direction (the direction indicated by the arrow C) about the pivot shaft 408, an end portion of the detection portion 407c opposite to the fixing belt 301, that is, an end portion opposite to the detection surface 407b located at one end portion, is defined as the other end portion 407f. A line connecting the detection surface 407b and the other end portion 407f is denoted by F. The line F is a line extending along the upper surface or the lower surface of the plate-shaped detection portion 407c. A plane orthogonal to the pivot shaft 408 is denoted by H. In this case, as illustrated in FIG. 8, the detection portion 407c is continuous with the base end portion 407e in a state where the line F is inclined with respect to the plane H such that the detection surface 407b is located below the other end portion 407f in the direction of gravity. FIG. 8 is a cross-sectional view taken along line E-E in FIG. 6.

As illustrated in FIG. 6, an intersection line between a plane of the plate-shaped detection portion 407c and a plane of the plate-shaped base end portion 407e is defined as bending line J. In this case, the detection portion 407c is continuously bent with respect to the base end portion 407e such that an angle α formed by the bending line J and the detection surface 407b becomes an acute angle. That is, in the present embodiment, by setting the angle α of the bending line J with respect to the detection surface 407b to an acute angle, the detection portion 407c is inclined by the angle β in the direction of gravity with respect to the horizontal direction, and the detection surface 407b is twisted with respect to the base end portion 407e. As a result, the detection portion 407c is inclined with respect to the base end portion 407e such that the detection surface 407b is located below the other end portion 407f in the direction of gravity, and the protrusion portion 407d is located below the detection portion 407c in the direction of gravity, regardless of the position of the fixing belt 301 in the width direction W. As a result, even when the inclination angle β of the detection portion 407c cannot be sufficiently secured, the distal end portion of the protrusion portion 407d can be located below the detection portion 407c in the direction of gravity, thereby making it possible to guide the lubricant adhering to the detection surface 407b to the protrusion portion 407d.

With the above configuration, the lubricant adhering to the belt position detection arm 407 is guided so as to adhere back to the inner peripheral surface of the fixing belt 301 without propagating through portions other than the detection surface 407b, the detection portion 407c, and the protrusion portion 407d. Therefore, it is possible to suppress leakage of the lubricant on the inner peripheral surface of the fixing belt 301, and it is possible to suppress contamination of portions other than the detection surface 407b, the detection portion 407c, and the protrusion portion 407d by the lubricant. Furthermore, since the lubricant is supplied back to the inner peripheral surface of the fixing belt 301, it is possible to suppress a decrease in the total amount of the lubricant on the inner peripheral surface of the fixing belt 301. Therefore, the slidability on the inner peripheral surface of the fixing belt 301 is favorably maintained, and the life of the fixing belt 301 can be improved.

### Other Embodiments

In the above-described embodiment, the detection portion 407c is inclined by the angle β in the direction of gravity with respect to the horizontal direction, but the detection portion 407c may not be inclined in this manner and may be continuously twisted with respect to the base end portion 407e. That is, the detection portion 407c only needs to be continuous with the base end portion 407e in a state where the line F is inclined with respect to the plane H such that the detection surface 407b is located below the other end portion 407f in the direction of gravity, and the angle β may be 0°. In other words, the end portion of the detection portion 407c on the side where the protrusion portion 407d is provided may be at the same height as the continuous portion 407g continuous with the base end portion 407e in the direction of gravity. However, from the viewpoint of guiding the lubricant adhering to the detection surface 407b to the protrusion portion 407d by gravity, it is preferable, as in the above-described embodiment, that the detection portion 407c is inclined by the angle β in the direction of gravity with respect to the horizontal direction and continuously twisted with respect to the base end portion 407e.

In addition, in the above-described embodiment, by setting the angle α formed by the bending line J and the detection surface 407b to an acute angle, the detection portion 407c is inclined by the angle β in the direction of gravity with respect to the horizontal direction, and the detection surface 407b is twisted with respect to the base end portion 407e. That is, by bending the detection portion 407c with respect to the base end portion 407e along the bending line J, the detection portion 407c is inclined with respect to the horizontal direction and twisted with respect to the base end portion 407e as described above. However, such a configuration may be obtained by bending the detection portion 407c with respect to the base end portion 407e in a plurality of stages. For example, the detection portion 407c may be bent in a direction inclined with respect to the base end portion 407e, and further, the detection portion 407c may be bent so as to be twisted with respect to the base end portion 407e at a position different from the bent portion.

In addition, in the above-described embodiment, the halogen heater is provided as a heating unit for heating the fixing belt on the heating roller. However, the heating unit may be provided on another stretching member, rather than the heating roller. In addition, the heating unit may be provided on the pad member. For example, a plate-shaped heat generating member such as a ceramic heater may be provided on a side of the pad member facing the fixing belt. The fixing belt may be heated by electromagnetic induction (IH). Further, in the above-described embodiment, instead of the heating unit disposed inside the roller, an external heating system in which another heating member is brought into contact with the belt or the roller from the outside for heating may be adopted.

Furthermore, in the above-described embodiment, the pressure roller is used as a driving rotary member. However, the driving rotary member may be an endless belt stretched by a plurality of stretching rollers and driven by any stretching roller. In addition, in the above-described embodiment, the pressure roller serving as a driving rotary member is pressurized against the belt to form a nip portion, but the belt may be pressurized against the driving rotary member. Furthermore, in the above-described embodiment, the fixing pad is used as a nip portion forming member, but the nip portion forming member may be a roller.

According to the present disclosure, it is possible to suppress leakage of the lubricant on the inner peripheral surface of the belt member.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-083646, filed May 19, 2025, which is hereby incorporated by reference herein in its entirety.

What is claimed is:

1. A fixing device configured to fix a toner image to a recording material by heating the toner image borne on the recording material, the fixing device comprising:
an endless belt member having an inner peripheral surface onto which a lubricant is applied;
a rotary member configured to rotate in contact with an outer peripheral surface of the belt member, and to form a nip portion with the belt member, the nip portion nipping and conveying the recording material;
a detection unit configured to detect a position of the belt member in a width direction intersecting a rotation direction of the belt member; and
a steering roller configured to stretch the belt member, the steering roller being tilted to move the belt member in the width direction according to a detection result of the detection unit,
wherein the detection unit includes:
a pivot shaft extending in a direction intersecting the width direction;
a base end portion configured to pivot about the pivot shaft;
a contact portion continuous with the base end portion, contacting an end portion, in the width direction, of the belt member, and configured to pivot about the pivot shaft together with the base end portion as the belt member moves in the width direction; and
a protrusion portion continuous with the contact portion, and protruding toward the center of the belt member relative to the contact portion in the width direction,
wherein the contact portion is continuous with the base end portion in a state in which a line connecting one end portion thereof contacting the belt member in a pivot direction around the pivot shaft and the other end portion thereof opposite to the belt member is inclined with respect to a plane orthogonal to the pivot shaft such that the one end portion is located below the other end portion in a direction of gravity, regardless of the position of the belt member in the width direction, and
wherein the protrusion portion has a distal end portion located below the contact portion in the direction of gravity and in a region overlapping the inner peripheral surface of the belt member in the width direction to guide the lubricant from the contact portion to the inner peripheral surface of the belt member.

2. The fixing device according to claim 1, wherein
each of the contact portion and the base end portion is a plate-shaped member, and
the contact portion is inclined with respect to the base end portion such that an end portion thereof on a side where the protrusion portion is provided is located below a continuous portion continuous with the base end portion in the direction of gravity.

3. The fixing device according to claim 2, wherein
the contact portion has a contact surface contacting the belt member at the one end portion, and
an angle formed by an intersection line between a plane of the contact portion and a plane of the base end portion and the contact surface is an acute angle.

4. The fixing device according to claim 1, wherein
the protrusion portion protrudes from the contact portion such that a distance between the distal end portion of the protrusion portion and the end portion of the belt member contacting the contact portion in the width direction is 2 mm or more regardless of the position of the belt member in the width direction.

5. The fixing device according to claim 1, further comprising:
a pad member disposed inside the belt member in the nip portion and in contact with the belt member.

6. The fixing device according to claim 1, further comprising:
a stretching roller disposed inside the belt member to stretch the belt member,
wherein the steering roller is disposed such that a rotation axis thereof is tiltable with respect to a predetermined direction parallel to a rotation axis direction of the stretching roller, the steering roller being tilted to control a position of the belt member with respect to the rotation axis direction of the stretching roller.

7. The fixing device according to claim 6, wherein
the stretching roller is a heating roller including a heating unit inside, so that the stretching roller is heated by the heating unit to heat the belt member.

8. The fixing device according to claim 1, further comprising:
a lubricant supply unit configured to supply the lubricant to the inner peripheral surface of the belt member.
